(19) United States
(12) Patent Application Publication
(10) Pub. No.: US 2008/0085350 A1
(43) Pub. Date: Apr. 10, 2008

(54) Palatability Enhancers for Pet Food and Methods of Manufacture

(75) Inventors: Zulin Shi, Naperville, IL (US); Hsi-Wen Chin, Marietta, GA (US); Bob J. Dull, Akron, OH (US); Jim G. Fotos, Westmont, IL (US)

Correspondence Address: SYNNESTVEDT LECHNER & WOODBRIDGE LLP, P O BOX 592, 112 NASSAU STREET, PRINCETON, NJ, 08542-0592, US

(73) Assignee: AFB INTERNATIONAL, St. Charles, MO (US)

(21) Appl. No.: 11/689,493

(22) Filed: Mar. 21, 2007

Related U.S. Application Data
(60) Provisional application No. 60/784,778, filed on Mar. 22, 2006.

(51) Int. Cl. A23K 1/00; A23K 1/10; A23K 1/14; A23K 1/16

(52) U.S. Cl. 426/535; 426/442; 426/601; 426/639; 426/641; 426/643; 426/644; 426/647; 426/650; 426/658

(57) ABSTRACT

A method for producing a palatability enhancer for a companion animal food product, wherein the method includes combining at least one aroma chemical selected from 2-methylfuran, 2-methylpyrrole, 2-methyl-thiophene and dimethyl disulfide with an animal or vegetarian digest composition. Companion animal food products containing the palatability enhancer are also disclosed.

### CROSS-REFERENCE TO RELATED APPLICATION

The present application claims priority benefit under 35 U.S.C. §119(e) of U.S. Provisional Application No. 60/784,778, the disclosure of which is incorporated by reference.

### BACKGROUND OF THE INVENTION

This invention is directed to a palatability enhancer for pet food and a method of its manufacture. Particularly, this invention relates to a palatability enhancer providing a savory flavor such as meat. More particularly, this invention relates to a process for improving the palatability of pet foods of either low or high moisture content by enhancing the flavor to increase its acceptability to cats and dogs.

It should be understood that the expression “dry pet food” as used herein includes foods having a low moisture content. For example, dry pet food may contain less than about 20% moisture so that the free water content is generally not sufficient to support the growth of microorganisms. High moisture content pet food is intended to include the semi-moist and canned types of foods. The invention is applicable to all types, but is particularly significant with dry foods which often are least appealing to domestic animals.

Advantages associated with dry pet foods are that they are generally more nutritious, on an equal weight basis, require less expensive packaging, and are more convenient to use than moist foods. However, domestic animals are often quite particular in their tastes and, therefore, improving palatability significantly improves the deliverability of a dry food. To improve taste, a variety of materials have been utilized to coat the surface and/or are mixed with the dry constituents to enhance the flavor. For example, phosphoric acid has been coated onto the surface of a dry cat food as a palatability enhancer. More specifically, U.S. Pat. No. 3,679,429 discloses a method for improving palatability of dry cat food by coating pellets of food with fat and palatability enhancing acids such as phosphoric or citric.

Palatability of dry pet foods may also be enhanced by the application of flavors. As an example, flavors are described in U.S. Pat. No. 5,186,964 as meat and cheese flavorings.

However, the use of meat or cheese flavoring is not always easy to accomplish. One complication in developing flavorants and palatability enhancers for pets is unpredictability. Moreover, flavorants which work effective with humans do not often work as effectively with pets. Similarly, a flavorant which is effective with one species may not work as well with a different animal group. Furthermore, pets are unable to express their preferences in an effective manner. Accordingly, palatability testing must be employed.

One primary area of focus has been to provide pet foods with a savory meat flavor. In fact, this effort exists simultaneously with respect to flavoring human foods. In animals, this has typically been accomplished using poultry viscera, heart and liver digests. However, this flavorant system is somewhat undesirable because it cannot meet with the increasing demand for palatability of pet foods, especially dry pet foods.

In humans, artificial meat flavorants have been investigated as demonstrated in U.S. Pat. No. 5,039,543 wherein it is disclosed that phospholipids, create a desirable meat aroma. Specifically, a flavorant stated to have a savory meat aroma and flavor is comprised of a phospholipid of animal origin and a sulfur containing compound which is reactive with the phospholipid. Similarly, in U.S. Pat. No. 4,045,587, herein incorporated by reference, a meat flavorant comprised generally of a cyclic carbonyl compound is disclosed. Further discussion of artificial meat flavors is provided in U.S. Pat. No. 3,892,878, herein incorporated by reference, wherein it is stated that certain alkane thiols and alkane mercapto sulfides alter the flavor of foodstuff to provide a roasted meat taste for humans.

Interestingly, notwithstanding the alleged success of these various artificial meat flavors, many human foods still rely on a combination of natural flavors and yeast. Furthermore, there has been no successful development of an artificial meat flavorant which has demonstrated success in meeting the particular and unique palatability demands of domestic animals.

Therefore, it would be desirable in the art of animal feed, to have available a meat flavorant which is easily storable, preservable and relatively inexpensive yet provides a savory meat-type flavor

### SUMMARY OF THE INVENTION

This need is met by the present invention.

A method for producing a palatability enhancer for a companion animal food product is presented. The method includes combining at least one aroma chemical selected from 2-methylfuran, 2-methylpyrrole, 2-methyl-thiophene and dimethyl disulfide with an animal or vegetarian digest composition. In one embodiment, the method further includes (a) combining at least one reducing sugar with said at least one aroma chemical and said digest composition to form a mixture; and (b) heating the mixture to initiate a reaction process. In another embodiment, the mixture further includes at least one reducing sugar is selected from xylose, rhamnose, glucose, fructose, and ribose. An additional embodiment includes adding at least one sulfur-containing compound selected from cysteine, cystine, glutathione, methionine, thiamine, sodium sulfide, and ammonium sulfide to the mixture.

In one embodiment, the aroma chemical is added to the mixture prior to or following heating. In another embodiment, the mixture is heated to between about 60° C. and about 180° C. In yet another embodiment, mixture is heated to between about 90° C. and about 130° C.

In one embodiment, the mixture is heated for a period of about 1 minute to about 4 days. In another embodiment, the reaction process is performed at a pH of between 2.5 and 10. In yet another embodiment, the reaction process is performed at a pH of between 6 and 9.

In another embodiment, the method further includes applying the palatability enhancer to a pork base, a chicken base, a vegetable base, a fish base, or a mixture thereof. In a further embodiment, the animal digest composition includes viscera selected from pork viscera, chicken viscera, and a combination thereof.

An additional embodiment further includes combining the palatability enhancer with a basal composition containing organosulfite salts formed by contacting unsaturated fatty acids that oxidize to form aldehydes or ketones in the basal composition with a source of bisulfite anions.

In yet another embodiment, the method further includes extruding the palatability enhancer with a basal composition to form a dry or semi-dry kibble. Another embodiment includes applying the palatability enhancer to the surface of a kibble after the kibble is extruded.

Also provided is a method for improving the palatability of a cooked moist companion animal food product wherein the food product is contacted with the palatability enhancer. In one embodiment, the palatability enhancer is contacted with said food product prior to cooking.

In another embodiment, the food product includes an additional palatability enhancing composition. In yet another embodiment, the additional palatability enhancing composition includes a palatability enhancing quantity of one or more compounds selected from pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

In one embodiment, the food product includes a food-grade raw meat or meat by-product. In another embodiment, the meat or meat by-product is selected from meat and meat by-products derived from beef, pork, sheep, lamb, poultry, duck, tuna, salmon, cod, whitefish and shrimp.

In yet another embodiment, the food product includes an animal or vegetable fat or oil.

In one embodiment, the method is a batch process. In another embodiment, the method is a continuous process.

Also provided is an extruded companion animal food composition containing the palatability enhancer. In another embodiment, a moist cooked companion animal food composition containing the palatability enhancer is also provided.

Other features of the present invention will be pointed out in the following description and claims, which disclose the principles of the present invention, and the best modes which are presently contemplated for carrying them out.

### BRIEF DESCRIPTION OF THE DRAWINGS

FIG. 1 depicts the structures of representative aroma chemicals for use in the present invention.

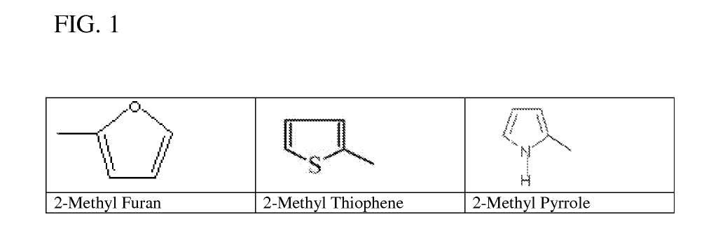

### DETAILED DESCRIPTION OF PREFERRED EMBODIMENTS

The present invention is directed to a method for producing and the resultant palatability enhancer, which provides an enhanced meaty flavor to dry or high moisture content animal feed.

Due to the lack of direct feedback from animal test subjects, the prevailing measurement of pet food flavor performance in the pet food industry is a two bowl, free choice methodology based on individual animal feed intake ratio with a minimum of 20 animals (dogs or cats) per test for two day duration as described in Palatability Testing: Two-Part Tests, Methods and Data Analysis Techniques; Griffin, R., September/October Pet Food Industry, 1996. Moreover, the complexities associated with the food evaluation process can be reduced by dealing fundamentally with the behavior of the animals. Specifically, it is assumed that the greater the food intake, the more palatable the food is. Such an assumption allows conclusions or inferences to be made about the animal's cognitive evaluation of the food.

The present invention involves combining at least one aroma chemical with an animal or vegetarian digest composition to generate a flavorant that can significantly improve the palatability performance of pet foods. The aroma chemical and digest composition can be further combined with at least one reducing sugar to form a mixture, which is then heated to initiate a reaction process for producing the flavorant. The mixture may further contain at least one sulfur-containing compound. The methods of the present invention are typically carried out in a batch or a continuous process.

Further, the methods of the present invention are typically carried out at elevated temperatures. The range of reaction temperatures is generally from about 60° C. to about 180° C., preferably about 90° C. to about 130° C., under a pressure in the range of about 100 to about 280 Kpa. The reaction process is typically conducted at a pH between 2.5 and 10, preferably at a pH between 6 and 9.

The reaction can take place over any suitable period of time, such as, for example, 1 minute to several days. Ten minutes to 5 hours is a typical reaction time. More specifically, the time of the reaction is often more dependant on the amount of time it takes to heat up the mixture to the desired final temperature and the time it takes to cool the reaction down sufficiently to terminate reactive mechanisms. However, the reaction time is recognized to impact on what reaction products are obtained.

The digest can be an animal digest or a vegetarian digest. Preferred animal digest compositions contain viscera, such as offal from pigs, chickens, cattle, lamb, or fish. Preferred viscera includes poultry heart. The animal digest composition may further contain non-visceral tissues, such as liver.

Preferred sulfur-containing compounds include cysteine, cystine, glutathione, methionine, thiamine, sodium sulfide, and ammonium sulfide. However, any sulfur-containing compounds could be used in the process provided that the desired reaction products are obtained. A typical amount of the sulfur-containing compound is from about 0.1 to about 10%, preferably from about 0.2 to about 2% by weight of the animal digest.

Suitable reducing sugars include xylose, rhamnose, glucose, fructose, and ribose. A typical amount of the reducing sugar is from about 0.1 to about 20%, preferably from about 1 to about 10% by weight of the animal digest.

The method includes adding an aroma chemical selected from 2-methylfuran, dimethyl disulfide, 2-methylthiophene, 2-methylpyrrole or a combination thereof to the animal digest composition prior to heating the composition. Alternatively, 2-methylfuran, dimethyl disulfide, 2-methylthiophene, 2-methylpyrrole or a combination thereof may be added to the composition after heating. When added, a typical amount of the aroma chemical is from about 5 parts-per-billion (ppb) to about 500 parts-per-million (ppm), preferably from about 20 ppb to about 300 ppm based upon the weight of the animal digest. A preferred amount of 2-methylfuran is from about 2 to about 1000 ppm. A preferred amount of 2-methylthiophene is from about 0.2 to about 1000 ppm. A preferred amount of dimethyl disulfide is from about 0.2 to about 1000 ppm.

The palatability enhancers produced by the above-discussed methods can be used in the produced form or can be blended with other ingredients to form a blended flavor. The palatability enhancers may also be combined with an additional palatability enhancing composition containing a palatability enhancing quantity of one or more compounds, such as pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid or hexamic acid salts.

Methods according to the present invention also include adding the palatability enhancer to a basal composition containing organosulfite salts, which were formed by contacting unsaturated fatty acids that oxidize to form aldehydes or ketones in the basal composition with a source of bisulfite anions. Methods for treating a basal composition to form organosulfite salts are described in U.S. Patent Application Ser. No. 60/692,035 filed on Jun. 17, 2005, the disclosure of which is incorporated herein by reference in its entirety.

The present invention also includes methods of preparing dry or semi-dry kibble and moist cooked companion animal foods containing the palatability enhancer prepared as disclosed above. Compositions containing the palatability enhancer, such as dry or semi-dry kibble and moist cooked companion animal foods containing the palatability enhancer are also provided.

As referred to within this description, dry and semi-dry companion animal foods generally relate to a nutritionally balanced mixture of proteinaceous and farinaceous materials having moisture contents of about 50% or less by weight. Moist companion animal food products generally relate to a nutritionally balanced mixture of proteinaceous and farinaceous materials having moisture contents above 50% by weight.

In moist food products, the proteinaceous and farinaceous materials are typically formed into a solid mass with a hydrocolloid such as gelatin. The meat in moist food products can be supplied by chunks of actual meat or by re-formed emulsified meat and meat by-products. Moist companion animal food may also optionally include a gravy component prepared from hydrocolloids and flavorings.

The companion animal food compositions described herein are not intended to be limited to a specific listing of ingredients because such ingredients will depend on such factors as, for example, the desired nutritional balance for the specific type of companion animal, and availability of ingredients to the manufacturer. In addition to the proteinaceous and farinaceous materials, the companion animal food composition may include vitamins, minerals, and other additives such as flavorings, preservatives, emulsifiers and humectants. The nutritional balance, including the relative proportions of vitamins, minerals, fat, protein and carbohydrate, is determined according to dietary standards known in the veterinary art. For example, the nutritional balance of a cat food composition is determined according to the known dietary requirements for cats.

Suitable proteinaceous material may include any material having a protein content of at least about 15% by weight including vegetable proteins such as soybean, cotton seed, and peanut; animal proteins such as casein, albumin, and fresh animal tissue including fresh meat tissue and fresh fish tissue; and dried or rendered meals such as fish meal, poultry meal, meat meal, bone meal and the like. Other types of suitable proteinaceous materials include wheat gluten or corn gluten, and microbial proteins such as yeast.

Suitable farinaceous material may comprise any material having a protein content of less than about 15% by weight and containing a substantial proportion of starches or carbohydrates, including grains such as corn, milo, alfalfa, wheat, barley, rice, soy hulls, and other grains having low protein content. In addition to the proteinaceous and farinaceous materials, other materials such as whey and other dairy by-products, as well as other carbohydrates may be added. In addition, known flavorings including, for example, corn syrup or molasses, may be added.

Generally, the term companion animal food product as used herein apply to commercially sold, nutritionally balanced compositions that are intended to provide substantially the sole diet for companion animals. Thus, such compositions may be described as having minimum protein contents at which companion animal health is maintained. However, the minimum protein content of the food varies according to the age and breeding status for the animal.

For example, a nutritionally balanced cat food composition for breeding females and kittens requires a minimum protein content of at least about 28% by weight on a dry matter basis. A nutritionally balanced cat food composition for non-breeding and adult cats requires a minimum protein content of about 26% by weight on a dry matter basis. More typically, the protein content of commercially available cat food compositions for adult, non-breeding cats is about 30% by weight on a dry matter basis, to insure that the food meets the nutritional requirements of any cat.

Additionally, vitamins and minerals are added according to known American Association of Feed Control Officials (AAFCO) guidelines. Such AAFCO profiles include calcium carbonate, potassium chloride, sodium chloride, choline chloride, taurine, zinc oxide, ferrous sulfate, vitamin E, vitamin A, vitamin B12, vitamin D3, riboflavin, niacin, calcium pantothenate, biotin, thiamine mononitrate, copper sulfate, folic acid, and pyroxidine.

Dry and semi-dry companion animal foods may be prepared by a variety of methods. One such method that is widely used on commercial basis is the cooker-extruder method. In the cooker-extruder method, dry ingredients are first blended together to form an admixture. This admixture is transferred into a steam conditioner where it is sufficiently moistened to become extrudable. The admixture then enters a cooker/extruder where it is cooked at an elevated temperature and pressure for a short period of time and then forced out of the apparatus through a die. This die forms the extruded product into a specific shape.

Individual pieces of product are created by periodically slicing off the end of the extruded stream of product. The individual pieces, or kibbles, are then dried in a hot air dryer. Generally, the product is dried until it contains less than about 15 percent moisture, and preferably about 5 to 12 percent moisture. The resulting pebbles or kibbles constitute the food composition.

With dry and semi-dry companion animal food products, the dried particles or pieces are then transferred by bulk conveyor to a coating drum and sprayed with animal fat. Other liquids such as, for example, citric acid or phosphoric acid may alternatively be applied to the pieces, or applied with or in addition to the animal fat, during or after which a coating of the palatability enhancer is typically applied.

The coating need not be a continuous layer, but preferably is uniform. After the fat cools, if not included with the fat coating, the palatability enhancer may be applied as either a dry power or a liquid, or both, while the product is mixing. A liquid palatability enhancer is typically sprayed on while a dry palatability enhancer is typically dusted on, preferably through a mesh screen to make the application more uniform on the particles or pieces. Alternatively, a palatability enhancer can be mixed with the fat and applied concurrently. Note that multiple coatings may be applied to achieve uniformity of the coating.

For extruded products, the palatability enhancer may be contacted with the livestock feed or companion animal food ingredients before extrusion by adding dry palatability enhancer to the ingredients during blending or steam conditioning, or adding aqueous palatability enhancer solution to the cooker/extruder. Aqueous palatability enhancer solution may also be applied to the extruded particles or pieces.

Moist companion animal food products that are gravy based are prepared by grinding meat, meat mimetics or meat by-products and then forming the ground mixture via low pressure extrusion through a steaming tunnel where it is cooked. Starch and binders are then added, after which the mixture is cut into pieces, mixed with water or gravy, sealed in cans and cooked in a hydrostat, continuous retort or rotary steritort

Moist companion animal food products that are not gravy based are prepared by macerating meat, meat mimetics or meat by-products and re-forming the macerated materials with water, starch and binders. The mixture is then sealed in cans and cooked in a hydrostat, continuous retort or rotary steritort.

Semi-moist products are prepared by macerating and mixing meat, meat by-products or meat mimetics, precooking the mixture, and then mixing the product with humectants such as glycerol, polysorbate, tween, and spans to hold water. The resulting mixture can be formed and put into a can or pouch for retorting or press-formed and cooked or retorted in a pouch.

For purposes of the present invention meat and meat by-products are defined as including meat and meat by-products from animal species and fish species. Examples of animal meat and meat by-products for which palatability can be improved by the method of the present invention include, but are not limited meat and meat by-products derived from beef, pork, sheep or lamb, poultry, duck, and the like. Examples of fish products and fish by-products that can be used include, but are not limited to, products and by-products derived from tuna, salmon, cod, whitefish, shrimp, and the like.

Examples of unsaturated animal fats and oils and vegetable oils for which palatability can be improved by the present invention include animal fats such as tallow, chicken fat and lard and vegetable oils such as canola oil, sunflower oil, safflower oil, cotton seed oil, canola oil, linseed oil, soybean oil, olive oil, corn oil, and the like, and byproducts thereof. Examples of animal oils include marine oils and byproducts thereof, such as marine oils from sources such as menhaden, herring, mackerel, caplan, tilapia, tuna, sardine, Pacific saury, krill, salmon, anchovy, skate, whale, seal, crab, shrimp, lobster, eel, mollusk, and the like. Vegetable oils also include oils derived from marine vegetation such as algae, kelp and the like.

The methods and compositions of the present invention optionally include one or more additional palatability enhancing compounds, examples of which include pyrophosphoric acid and the sodium, potassium, calcium and magnesium salts thereof, phosphoric acid and the sodium, potassium, calcium and magnesium salts thereof, sodium, potassium, calcium and magnesium tripoly-phosphate salts, potassium, calcium and magnesium hexapolyphosphate salts, or organic acids such as citric, tartaric, fumaric, lactic, acetic, formic and hexamic acids and the sodium, potassium, calcium and magnesium salts thereof, and the like. Examples of suitable palatability enhancing compositions are disclosed in U.S. Pat. App. Publication No. 2005/0106285 published May 19, 2005, the disclosure of which is incorporated herein by reference.

Moist companion animal food compositions are also included that have been contacted with a palatability enhancer, preferably prior to cooking. Preferred products are contacted with a palatability enhancer by contacting raw materials before such raw materials are added to the food product.

The palatability enhancers of the present invention contain from about 0.1% to 80% by weight of one or more palatability enhancing compounds, examples of which are listed above. Palatability enhancing compound levels between about 5 and about 50% by weight are preferred, with levels between about 10 and about 35% by weight more preferred, and levels between about 15 and about 30% by weight even more preferred.

The palatability enhancers are formulated and applied so that the one or more palatability enhancing compounds constitute from about 0.01 to about 500 ppm by weight of the finished pet food product. Preferably, the palatability enhancers are formulated so that the one or more palatability enhancing compounds constitute from about 0.1 ppm to about 0.05% by weight of the finished pet food product, more preferably between about 1 to about 100 ppm by weight, and even more preferably between about 2 and about 40 ppm.

Among the preferred palatability enhancers according to the present invention are palatability enhancers containing from about 5 to about 99 wt. % of one or more products or by-products selected from the above described meat products, meat by-products, meat mimetics, dairy products and dairy by-products. Examples of dairy products and dairy by-products that can be used include, but are not limited to, products and by-products derived from cheese, milk protein, whey, and the like.

Preferred products and by-products that may be present alone or in combination include products and by-products of beef and poultry. Fish products and by-products are also preferred. A product or by-product level between about 20 and about 70 wt. % is preferred.

Among the same or other preferred palatability enhancers according to the present invention are palatability enhancers containing from about 0.01 to about 60 wt. % of one or more amino acids. Examples of amino acids that can be used include, but are not limited to, alanine, glycine, cysteine, and the like. Preferred amino acids that may be present alone or in combination include glycine, L-alanine, and the like. An amino acid level between about 0.1 and about 4.0 wt. % is preferred.

Among the same or other preferred palatability enhancers according to the present invention are palatability enhancers containing from about 5 to about 70 wt. % of one or more microbial or vegetable proteins. Examples of microbial proteins that can be used include, but are not limited to, brewer's yeast, baker's yeast, and the like. Examples of vegetable proteins that can be used include, but are not limited to, corn gluten, soy protein, soy flour, hydrolyzed vegetable protein (HVP), and the like. Microbial or vegetable protein levels from about 10 to about 40 wt. % are preferred.

Among the same or other preferred palatability enhancers according to the present invention are palatability enhancers containing from about 0.01 to about 50 wt. % of one or more carbohydrates. Examples of carbohydrates that can be used include, but are not limited to, glucose, xylose, fructose, starch hydrolysates, and the like. A carbohydrate level between about 10 and about 30 wt. % is preferred.

One example of a preferred formulation has a solids content of from about 10 to about 40 wt. % of one or more palatability enhancing compounds; about 30 to about 60 wt. % of one or more products or by-products selected from animal products, animal by-products, fish products, fish by-products, dairy products and dairy by-products; from about 25 to about 35 wt. % of one or more sources of microbial proteins; from about 1 to about 9 wt. % by weight bisulfite; from about 0.1 to about 1.0 wt. % of one or more anti-oxidants; from about 2 to about 4 wt. % of one or more amino acids; and from about 0.5 to about 60 wt % of one or more carbohydrates.

Dry formulations have a solids content of about 96 wt %. Liquid formulations may be diluted to a total solids content as low as about 10 wt % with water and preferably to a solids content no more than about 50 wt % to obtain a viscosity and rheology suitable for spray application.

The water content may also be supplied by moisture-containing or liquid components such as aqueous bisulfite solutions, the amounts of which are selected by well-known techniques to maintain the solids content of the product. Liquid formulations according to the present invention have a pH between about 2 and about 9. Preferred liquid formulations have a pH between about 2 and about 3.

For example, a formula for a palatability enhancer derived from chicken byproducts according to the present invention is as follows:

10 to 90% by weight chicken byproducts digest;

2 to 15% by weight phosphoric acid, 75%;

0 to 10% by weight expansion water;

1 to 7% by weight sodium hydroxide, 50%;

0.5 to 10% by weight xylose 40% solution;

0 to 5% by weight 1-cysteine hydrochloride;

0.34% by weight sorbic acid 20% solution;

0 to 2% by weight thiamine; and

0.01% by weight mixed tocopherols, 50%.

To make a liquid palatability enhancer formulation according to the present invention, for example, commercially available liquid ingredients are combined in a mixer. Wet ingredients are ground or emulsified to a slurry and the liquid ingredients are combined therewith. A commercially available protease may be added to the slurry to hydrolyze proteins, and later inactivated with heat, acid or another method. Preservatives such as sorbic acid can also be added. Water is added to adjust the viscosity and the solids content of the slurry to facilitate spray application. The wet palatability enhancer is sprayed onto the product so as to achieve a uniform coating and permitted to dry.

A dry formulation of the palatability enhancer is prepared according to one embodiment of the present invention, by combining commercially available dry ingredients, including the palatability enhancing compound, dry metabisulfite, amino acids, inorganic salts and organic materials in the desired proportions in a batch mixer and blending to homogeneity prior to drying.

According to another dry formulation embodiment, wet and dry ingredients are combined by mixing the wet ingredients with all or some of the dry ingredients in a mixer until a homogenous mixture is formed. The mixture is dried by evaporation or lyophilization, for example, to form a dry, powdery product that is then blended with any remaining dry ingredients in a tumbler until a homogeneous mixture is formed.

The following non-limiting examples set forth below illustrate certain aspects of the invention. These examples are not intended to limit the scope, but rather to exemplify preferred embodiments. All parts and percentages are by weight unless otherwise noted and all temperatures are in degrees Celsius.

### EXAMPLES

### Example 1

### Preparation of a Chicken Byproducts-Derived Palatability Enhancer

A reaction mixture of chicken byproducts digest, xylose solution, 1-cysteine hydrochloride, and thiamine was prepared using the following amounts:

| COMPONENT | PERCENT (wt/wt) |
|---|---|
| Chicken Byproducts Digest | 70.00 |
| Phosphoric Acid, 75% | 10.25 |
| Expansion Water | 7.08 |
| Sodium Hydroxide, 50% | 6.12 |
| Xylose 40% Solution | 5.00 |
| 1-Cysteine Hydrochloride | 1.00 |
| Sorbic Acid Solution 20% | 0.34 |
| Thiamine | 0.20 |
| Mixed Tocopherols 50% | 0.01 |

The pH of the mixture was adjusted to 8 using the sodium hydroxide solution.

The reaction mixture was then steam heated to a temperature between 90° C. and 100° C. to initiate the reaction. Steam contributed to the formula weight in the form of condensed expansion water. The reaction mixture was held at the target temperature for 90 minutes for the development of desirable meaty aromas. The resulting palatability enhancer was preserved using the formulated amounts of phosphoric acid, sorbic acid solution, and the mixed tocopherols.

### Example 2

### Palatability Testing of Byproducts-Derived Enhancer vs. Liver-Derived Enhancer

In a first formulation, a commercially-available standard dry dog food (Crosswind Industries, Kansas) was coated with 2% (wt/wt) of the palatability enhancer prepared according to Example 1. In a second formulation, the standard dry dog food was coated with 2% (wt/wt) of a commercial palatability enhancer derived from poultry liver.

A panel of approximately 20 dogs was presented with the two formulations in a standard two-bowl, two-day, free choice method. The consumption by the subject dogs was at parity for the two formulations.

### Example 3

### Palatability Testing of Byproducts-Derived Enhancer vs. Byproducts Digest

In a first formulation, a commercially-available standard dry dog food (Crosswind Industries, Kansas) was coated with 2% (wt/wt) of the chicken byproducts digest used as the starting material for preparing the palatability enhancer described in Example 1. In a second formulation, the standard dry dog food was coated with 2% (wt/wt) of a commercial palatability enhancer derived from poultry liver.

The palatability testing was conducted as described in Example 2. The subject dogs preferred the liver-derived control flavor to the byproducts digest with a consumption ratio of about 2.8 to 1 and a first-choice ratio of about 5.3 to 1.

### Example 4

### Palatability Testing of Byproducts-Derived Enhancer with 2 ppm 2-Methyl Furan vs. Liver-Derived Enhancer

In a first formulation, a commercially-available standard dry dog food (Crosswind Industries, Kansas) was coated with 2% (wt/wt) of the palatability enhancer prepared according to Example 1, which had been spiked with 2 ppm 2-methyl furan. In a second formulation, the standard dry dog food was coated with 2% (wt/wt) of a commercial palatability enhancer derived from poultry liver.

The palatability testing was conducted as described in Example 2. The subject dogs preferred the 2-methyl furan/byproducts-derived flavor with a consumption ratio of about 1.7 to 1 and a first choice ratio of about 2 to 1.

### Example 5

### Palatability Testing of Byproducts-Derived Enhancer with 0.02 ppm 2-Methyl Furan vs. Liver-Derived Enhancer

In a first formulation, a commercially-available standard dry dog food (Crosswind Industries, Kansas) was coated with 2% (wt/wt) of the palatability enhancer prepared according to Example 1, which had been spiked with 0.02 ppm 2-methyl furan. In a second formulation, the standard dry dog food was coated with 2% (wt/wt) of a commercial palatability enhancer derived from poultry liver.

The palatability testing was conducted as described in Example 2. The subject dogs again preferred the 2-methyl furan/byproducts-derived flavor with a consumption ratio of about 1.4 to 1 and a first choice ratio of about 2 to 1.

From the preceding description of various embodiments of the present invention, it is evident that the objects of the invention are attained. Although the invention has been described and illustrated in detail, it is to be clearly understood that the same is intended by way of illustration and example only and is not to be taken by way of limitation. Accordingly, the spirit and scope of the invention are to be limited only by the terms of the appended claims.

What is claimed:

1. A method for producing a palatability enhancer for a companion animal food product comprising combining at least one aroma chemical selected from the group consisting of 2-methylfuran, 2-methylpyrrole, 2-methyl-thiophene and dimethyl disulfide with an animal or vegetarian digest composition.

2. The method of claim 1, further comprising (a) combining at least one reducing sugar with said at least one aroma chemical and said digest composition to form a mixture; and (b) heating the mixture to initiate a reaction process.

3. The method of claim 2 wherein said aroma chemical is added to the mixture prior to or following heating.

4. The method of claim 1 or 2 further comprising applying said palatability enhancer to a pork base, a chicken base, a vegetable base, a fish base, or a mixture thereof.

5. The method of claim 1 or 2, wherein said animal digest composition comprises viscera selected from the group consisting of pork viscera, chicken viscera, and a combination thereof.

6. The method of claim 2, further comprising at least one sulfur-containing compound selected from the group consisting of cysteine, cystine, glutathione, methionine, thiamine, sodium sulfide, and ammonium sulfide.

7. The method of claim 2, wherein said at least one reducing sugar is selected from the group consisting of xylose, rhamnose, glucose, fructose, and ribose.

8. The method of claim 2, wherein said mixture is heated to between about 60° C. and about 180° C.

9. The method of claim 8, wherein said mixture is heated to between about 90° C. and about 130° C.

10. The method of claim 2, wherein said mixture is heated for a period of about 1 minute to about 4 days.

11. The method of claim 2, wherein said reaction process is performed at a pH of between 2.5 and 10.

12. The method of claim 11, wherein said reaction process is performed at a pH of between 6 and 9.

13. The method of claim 1, further comprising combining said palatability enhancer with a basal composition containing organosulfite salts formed by contacting unsaturated fatty acids that oxidize to form aldehydes or ketones in the basal composition with a source of bisulfite anions.

14. The method of claim 1 further comprising extruding said palatability enhancer with a basal composition to form a dry or semi-dry kibble.

15. The method of claim 1 further comprising applying said palatability enhancer to the surface of a kibble after the kibble is extruded.

16. A method for improving the palatability of a cooked moist companion animal food product comprising contacting said food product with a palatability enhancer prepared according to the method of claim 1.

17. The method of claim 16, wherein said palatability enhancer is contacted with said food product prior to cooking.

18. The method of claim 1, wherein said food product further comprises an additional palatability enhancing composition.

19. The method of claim 18, wherein said additional palatability enhancing composition comprises a palatability enhancing quantity of one or more compounds selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

20. The method of claim 1, wherein said food product comprises a food-grade raw meat or meat by-product.

21. The method of claim 20, wherein said meat or meat by-product is selected from the group consisting of meat and meat by-products derived from beef, pork, sheep, lamb, poultry, duck, tuna, salmon, cod, whitefish and shrimp.

22. The method of claim 1, wherein said food product comprises an animal or vegetable fat or oil.

23. The method of claim 1, wherein said method is a batch process.

24. The method of claim 1, wherein said method is a continuous process.

25. An extruded companion animal food composition comprising the palatability enhancer prepared according to the method of claim 1.

26. A moist cooked companion animal food composition comprising the palatability enhancer prepared according to the method of claim 1.
